(19) United States
(12) Patent Application Publication
(10) Pub. No.: US 2021/0187886 A1
(43) Pub. Date: Jun. 24, 2021

(54) Brominated Isobutylene Paramethyl-Styrene Elastomer Curing Bladders

(71) Applicant: ExxonMobil Chemical Patents Inc., Baytown, TX (US)

(72) Inventors: Sushil K. Mandot, Houston, TX (US); Manomohan Bisoi, Bengaluru, Karnataka (IN); Ck Shanawas, Bangalore, Karnataka (IN); Yoshiyuki Tanaka, Tokyo (JP)

(21) Appl. No.: 17/252,940

(22) PCT Filed: May 22, 2019
(86) PCT No.: PCT/US2019/033530

§ 371 Date: Dec. 16, 2020

Related U.S. Application Data
(60) Provisional application No. 62/690,474, filed on Jun. 27, 2018.

(51) Int. Cl. B29D 30/06; C08K 5/47; C08L 23/28

(52) U.S. Cl. CPC B29D 30/0654; C08K 5/47; B29K 2019/00; B29D 2030/0655; C08L 23/28

(57) ABSTRACT

A composition can comprise: an elastomeric composition formed into a curing bladder, the elastomeric composition comprising: 100 parts per hundred parts rubber (phr) of an elastomer comprising a C₄-C₇ isoolefin, a non-halogenated alkylstyrene, and a halogenated alkylstyrene; 1 phr to 7.5 phr alkyl phenol formaldehyde resin; and 0.5 phr to 5 phr mercaptobenzothiazole disulfide. A related method of making a tire curing bladder comprises: mixing 100 phr of an elastomer composition comprising a C₄-C₇ isoolefin, a non-halogenated alkylstyrene, and a halogenated alkylstyrene, 1 phr to 7.5 phr alkyl phenol formaldehyde resin, and 0.5 phr to 5 phr mercaptobenzothiazole disulfide; and molding and curing the mixture into the shape of a tire curing bladder.

### CROSS-REFERENCE TO RELATED APPLICATIONS

This invention claims priority to and the benefit of U.S. Ser. No. 62/690,474, filed Jun. 27, 2018, which is incorporated herein by reference in its entirety.

### FIELD OF THE INVENTION

This invention relates to tire curing bladders, their manufacture, and their use.

### BACKGROUND

Pneumatic rubber vehicle tires are generally produced by building, molding, and curing a green or uncured tire in a molding press. Using this process, a green tire construct is pressed outwardly against a mold surface by means of an inner fluid-expandable bladder, commonly referred to as a curing bladder. By this method, the green tire is shaped against the outer mold surface, which defines the tire tread pattern and configuration of the sidewalls. By application of heat and pressure via the curing bladder, the tire is molded and vulcanized at elevated temperatures.

Briefly, the proper selection of elastomers and compounding materials for the bladder formulation is essential in ensuring durability, required service life, and efficient curing bladder operation in a tire factory. Butyl rubbers (e.g., isobutylene-isoprene copolymers) are the elastomer of choice in curing bladder formulations due to excellent heat aging resistance, good flex and tear resistance, and impermeability to air, inert gases, and water vapor. Fundamentally, this is due to the superior heat and steam resistance of cured butyl rubber and this has resulted in its wide use for high heat resistant applications.

Recently, there has been a global shortage of butyl rubber, creating a need to use less butyl rubber in the manufacture of curing bladders. There is also an ongoing need to improve the durability and service life of curing bladders, which is referred to often as a pull point. When a pull point occurs, it can lead to the loss of up to six tires in a typical tire manufacturing process. There is also an ongoing need to improve heat transport through the bladder to improve the efficiency of the curing process and increase production rates on the vulcanization press.

### SUMMARY

This invention relates to tire curing bladders, their manufacture, and their use.

In one embodiment of the disclosure, a composition comprises: an elastomeric composition formed into a curing bladder, the elastomeric composition comprising: 100 parts per hundred parts rubber (phr) of an elastomer comprising a C₄-C₇ isoolefin, a non-halogenated alkylstyrene, and a halogenated alkylstyrene; 1 phr to 7.5 phr alkyl phenol formaldehyde resin; and 0.5 phr to 5 phr mercaptobenzothiazole disulfide.

In another embodiment of the disclosure, a method of making a tire curing bladder comprises: mixing 100 parts per hundred parts rubber (phr) of an elastomer composition comprising a C₄-C₇ isoolefin, a non-halogenated alkylstyrene, and a halogenated alkylstyrene, 1 phr to 7.5 phr alkyl phenol formaldehyde resin, and 0.5 phr to 5 phr mercaptobenzothiazole disulfide; and molding and curing the mixture into the shape of a tire curing bladder.

### DETAILED DESCRIPTION

The curing bladders of the present invention are formed by curing a brominated isobutylene paramethyl-styrene elastomer with a curative system that comprises, consists essentially of, or consists of alkyl phenol formaldehyde resin and mercaptobenzothiazole disulfide. The brominated isobutylene paramethyl-styrene elastomer comprises a C₄-C₇ isoolefin (e.g., isobutylene), a non-halogenated alkylstyrene (e.g., p-methylstyrene), and a halogenated alkylstyrene (e.g., p-bromomethylstyrene).

Various specific embodiments, versions, and examples are described herein, including exemplary embodiments and definitions that are adopted for purposes of understanding the claimed invention. While the following detailed description gives specific embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

### Definitions

A “curing bladder” is a flexible, inflatable bladder used or capable of being inflated to mold and/or cure elastomeric articles such as tires in a tire press.

The term “elastomer” as used herein refers to any polymer or combination of polymers consistent with the ASTM D1566-15 definition, incorporated herein by reference. As used herein, the term “elastomer” may be used interchangeably with the term “rubber.”

As used herein, “polymer” may be used to refer to homopolymers, copolymers, terpolymers, etc. As used herein, the term “copolymer” is meant to include polymers having two or more monomers. Polymers, in some embodiments, may be produced (1) by mixing all multiple monomers at the same time or (2) by sequential introduction of the different comonomers. The mixing of comonomers may be done in one, two, or possible three different reactors in series and/or in parallel. As used herein, when a polymer is referred to as “comprising” a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, “diolefin” refers to an unsaturated hydrocarbon having at least two unsaturated bonds between carbon atoms. While normally, a diolefin will have two double bonds, a molecule with additional double bonds or with one or more triple bonds may also function as a diolefin for purposes of this invention. The mere addition of a double or triple bond to a diene does not defeat the improvement of the invention. At the present time, the vast majority of possible feedstocks are compounds having only two double bonds. However, unsaturated hydrocarbons such as n-1,3,5 hexatriene or n-1,4,6-heptatriene or propyne also meet the requirements to function as a “diolefin” in the context of this invention.

The term “blend” as used herein refers to a mixture of two or more polymers. Blends may be produced by, for example, solution blending, melt mixing, or compounding in a shear mixer. Solution blending is common for making adhesive formulations comprising baled butyl rubber, tackifier, and oil. Then, the solution blend is coated on a fabric substrate, and the solvent evaporated to leave the adhesive.

The term “monomer” or “comonomer,” as used herein, can refer to the monomer used to form the polymer (i.e., the unreacted chemical compound in the form prior to polymerization) and can also refer to the monomer after it has been incorporated into the polymer, also referred to herein as a “[monomer]-derived unit”. Different monomers are discussed herein including, but not limited to, C₄-C₇ isoolefin monomers, non-halogenated alkylstyrene monomers, halogenated styrene monomers, and diolefin monomers.

As used herein, “phr” means “parts per hundred parts rubber,” where the “rubber” is the total rubber content of the composition. Herein, both the elastomer compositions of the present invention and additional rubbers, when present, are considered to contribute to the total rubber content. Thus, for example, a composition having 30 parts by weight of elastomer of the present invention and 70 parts by weight of a second rubber (e.g., butyl rubber) may be referred to as having 30 phr elastomer and 70 phr second rubber. Other components added to the composition are calculated on a phr basis. That is, addition of 50 phr of oil means, for example, that 50 g of oil are present in the composition for every 100 g of total rubber. Unless specified otherwise, phr should be taken as phr on a weight basis.

“Mooney viscosity” as used herein is the Mooney viscosity of a polymer or polymer composition. The polymer composition analyzed for determining Mooney viscosity should be substantially devoid of solvent. For instance, the sample may be placed on a boiling-water steam table in a hood to evaporate a large fraction of the solvent and unreacted monomers, and then, dried in a vacuum oven overnight (12 hours, 90° C.) prior to testing, in accordance with laboratory analysis techniques, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-17, but with the following modifications/clarifications of that procedure. First, sample polymer is pressed between two hot plates of a compression press prior to testing. The plate temperature is 125° C.+/−10° C. instead of the 50+/−5° C. recommended in ASTM D1646-17, because 50° C. is unable to cause sufficient massing. Further, although ASTM D1646-17 allows for several options for die protection, should any two options provide conflicting results, PET 36 micron should be used as the die protection. Further, ASTM D1646-17 does not indicate a sample weight in Section 8; thus, to the extent results may vary based upon sample weight, Mooney viscosity determined using a sample weight of 21.5+/−2.7 g in the D1646-17 Section 8 procedures will govern. Finally, the rest procedures before testing set forth in D1646-17 Section 8 are 23+/−3° C. for 30 min in air; Mooney values as reported herein were determined after resting at 24+/−3° C. for 30 min in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4 @ 125° C. or ML, 1+8 @ 125° C.), where M is the Mooney viscosity number, L denotes large rotor (defined as ML in ASTM D1646-17), 1 is the pre-heat time in minutes, 4 or 8 is the sample run time in minutes after the motor starts, and 125° C. is the test temperature. Thus, a Mooney viscosity of 90 determined by the aforementioned method would be reported as a Mooney viscosity of 90 MU (ML, 1+8 @ 125° C.) or 90 MU (ML, 1+4 @ 125° C.). Alternatively, the Mooney viscosity may be reported as 90 MU; in such instance, it should be assumed that the just-described (ML, 1+4 @ 125° C.) method is used to determine such viscosity, unless otherwise noted. In some instances, a lower test temperature may be used (e.g., 100° C.), in which case Mooney is reported as Mooney Viscosity (ML, 1+8 @ 100° C.), or @ T° C. where T is the test temperature.

Numerical ranges used herein include the numbers recited in the range. For example, the numerical range “from 1 wt % to 10 wt %” includes 1 wt % and 10 wt % within the recited range.

### Elastomer

The brominated isobutylene paramethyl-styrene elastomer described herein comprises at least one C₄ to C₇ isoolefin-derived monomer. The elastomer can be halogenated. Examples of isoolefins that may be used as a C₄ to C₇ compound include, but are not limited to, isobutylene, isobutene, 2-methyl-1-butene, 3-methyl-1-butene, 2-methyl-2-butene, and 4-methyl-1-pentene. The elastomer also includes at least one non-halogenated alkylstyrene monomer and at least one halogenated alkylstyrene monomer. Examples of non-halogenated alkylstyrene monomers include, but are not limited to, α-methylstyrene, tert-butylstyrene, and styrene units substituted in the ortho, meta, or para position with a C₁ to C₅ alkyl or branched chain alkyl. In a desirable embodiment, the non-halogenated alkylstyrene monomer is p-methylstyrene. Examples of halogenated alkylstyrene monomers include, but are not limited to, halomethylstyrene and styrene units substituted in the ortho, meta, or para position with a halogenated C₁ to C₅ alkyl or branched chain alkyl, where the halogen may be chlorine or bromine. In a desirable embodiment, the halogenated alkylstyrene monomer is p-halomethylstyrene, preferably p-bromomethylstyrene or p-chloromethylstyrene.

The elastomers described herein can be random elastomeric copolymers of a C₄ to C₇ isoolefin (e.g., isobutylene), a non-halogenated alkylstyrene (e.g., p-methylstyrene), and a halogenated alkylstyrene (e.g., p-bromomethylstyrene). The non-halogenated alkylstyrene and halogenated alkylstyrene monomers each can contain at least 80%, more preferably at least 90% by weight of the corresponding para-isomer. Preferred materials may be characterized as elastomers containing the following monomer units randomly spaced along the polymer chain:

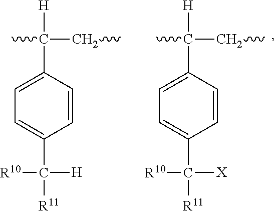

wherein R¹⁰ and R¹¹ are independently hydrogen, lower alkyl, preferably C₁ to C₇ alkyl, and primary or secondary alkyl halides and X is a functional group such as halogen.

Preferably, R¹⁰ and R¹¹ are hydrogen. Up to 60 mole percent of the para-substituted styrene present in the elastomer structure may be a functionalized structure in one embodiment, and in another embodiment from 0.1 to 5 mole percent. In yet another embodiment, the amount of functionalized structure is from 0.4 to 1 mole percent.

The functional group X may be halogen or a combination of a halogen and some other functional group such which may be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; nitrile; amino and mixtures thereof. These functionalized isoolefin copolymers, their method of preparation, methods of functionalization, and cure are more particularly disclosed in U.S. Pat. No. 5,162,445, and in particular, the functionalized amines as described below.

Most useful of such functionalized materials are elastomeric random copolymers of isobutylene, p-methylstyrene, and p-bromomethylstyrene where the p-methylstyrene and the p-bromomethylstyrene are present in a combined amount of 0.5 to 20 weight percent (wt %) or 0.5 to 30 wt %. These halogenated elastomers are commercially available as EXXPRO™ Elastomers (ExxonMobil Chemical Company, Houston Tex.), and abbreviated as “BIMSM.” These elastomers can, if desired, have a substantially homogeneous compositional distribution such that at least 95% by weight of the polymer has a combined the p-methylstyrene and the p-bromomethylstyrene content within 15% of the combined the p-methylstyrene and the p-bromomethylstyrene content of the polymer.

Preferably, the elastomers contain from 0.1 to 7.5 mole percent (mol %) of halogenated alkylstyrene derived units relative to the combined non-halogenated and halogenated alkylstyrene derived units in the polymer. For example, the amount of bromomethyl groups is from 0.2 to 3.0 mol %, from 0.3 to 2.8 mol %, from 0.3 to 2.0 mol %, or from 0.4 to 1.0 mol %, wherein a desirable range may be any combination of any upper limit with any lower limit. Expressed another way, preferred copolymers contain from 0.3 to 4.5 wt % of bromine, based on the weight of the polymer, from 0.4 to 4 wt % bromine, and from 0.6 to 1.5 wt % bromine. In one embodiment of the invention, the elastomer is a copolymer of C₄ to C₇ isoolefin derived units (or isomonoolefin), p-methylstyrene derived units, and p-halomethylstyrene derived units, wherein the p-halomethylstyrene units are present in the elastomer from 0.4 to 1.0 mol % based on the total number of p-methylstyrene and p-halomethylstyrene derived units, and wherein the p-methylstyrene derived units are present from 3 wt % to 15 wt % based on the total weight of the polymer, or from 10 wt % to 12 wt %. The p-halomethylstyrene can be, for example, p-bromomethylstyrene.

Optionally, the elastomers can further comprise one or more diolefin monomers, wherein the C₄ to C₇ isoolefin is not the same as the diolefin. Examples of diolefins include, but are not limited to, isoprene; cis-1,3-pentadiene; trans-1,3-pentadiene; cyclopentene; cyclopentadiene; beta-pinene; limonene; and combinations thereof.

The diene monomers can be present in the elastomers in an amount of 0.5 wt % to 10 wt % of the polymer, or 1 wt % to 8 wt %, or 2 wt % to 5 wt %.

An example elastomers can include at least one C₄ to C₇ isoolefin-derived monomer (e.g., isobutylene), at least one non-halogenated alkylstyrene-derived monomer (e.g., p-methylstyrene), at least one halogenated alkylstyrene-derived monomer (e.g., p-bromomethylstyrene), and at least one diene-derived monomer (e.g., isoprene). For example, the at least one C₄ to C₇ isoolefin-derived monomer can be present at about 60 wt % to about 99 wt %, the at least one non-halogenated alkylstyrene-derived monomer and at least one halogenated alkylstyrene-derived monomer cumulatively can be present at about 0.5 wt % to about 30 wt % with the at least one halogenated alkylstyrene-derived monomer being 0.1 mol % to 7.5 mol % of the combined content of the at least one non-halogenated alkylstyrene-derived monomer and the at least one halogenated alkylstyrene-derived monomer, and the at least one diene-derived monomer can be present at about 0.5 wt % to about 10 wt %.

In accordance with the invention, the elastomer has a (ML, 1+8 @ 100° C.) Mooney viscosity less than 65, for example, 20 to 60, 25 to 50, 30 to 45, or 32 to 37.

Desirable brominated isobutylene paramethyl-styrene elastomers can also be characterized by a narrow molecular weight distribution (Man) of less than 5, more preferably less than 2.5.

The elastomers can also be characterized by a preferred viscosity average molecular weight in the range of from 2,000 up to 2,000,000 and a preferred number average molecular weight in the range of from 2500 to 750,000 as determined by gel permeation chromatography. In particular embodiments it may be preferable to utilize two or more elastomers having a similar backbone, such as a low molecular weight elastomer having a weight average molecular weight less than 150,000 can be blended with a high molecular weight elastomer having a weight average molecular weight greater than 250,000, for example.

In an embodiment, the polymers may be prepared by a slurry polymerization of the monomer mixture using a Lewis acid catalyst, followed by halogenation, preferably bromination, in solution in the presence of halogen and a radical initiator such as heat and/or light and/or a chemical initiator and, optionally, followed by electrophilic substitution of bromine with a different functional moiety. In an embodiment, the polymers may be prepared by directly functionalizing with different functional moiety without a bromination step.

### Curing System

As used herein, the term “curing system” refers to the combination of the curative agents. Examples of curative agents include, but are not limited to, sulfur, metals, metal oxides such as zinc oxide, peroxides, organometallic compounds, radical initiators, fatty acids, accelerators, and other agents common in the art.

The curing bladders of the present invention are formed by an elastomeric composition produced by curing the elastomers described herein with a curative system that comprises, consists essentially of, or consists of alkyl phenol formaldehyde resin and mercaptobenzothiazole disulfide (MBTS). Optionally, metal oxides and/or additional accelerators can be further included in the curative system.

The alkyl phenol formaldehyde resin, which is an accelerator, can be present at 1 phr to 7.5 phr, or 2 phr to 6 phr, or 3 phr to 5 phr. Examples of alkyl phenol formaldehyde resins include, but are not limited to, SP1045™ (octyl phenol formaldehyde resin, available from SI Group), SP1055™ (brominated octyl phenol formaldehyde resin, available from SI Group), and combinations thereof.

MBTS can act as an accelerator in the curing system. Other accelerators include, but are not limited to, stearic acid, diphenyl guanidine (DPG), tetramethylthiuram disulfide (TMTD), N-t-butyl-2-benzothiazole sulfenamide (TBBS), N-cyclohexyl-2-benzothiazole-sulfenamide (CBS), thioureas, and combinations thereof. One or more accelerator can be present individually at 0.1 phr to 5 phr, or 0.5 phr to 4 phr, or 1 phr to 3 phr. Specifically, the MBTS can be present at 0.5 phr to 5 phr, or 0.75 phr to 4 phr, or 1 phr to 3 phr, or 1.4 phr to 2 phr. In some preferred embodiments, MBTS is present at 0.5 phr to 5 phr and stearic acid is present at 0.5 phr to 5 phr. More preferably, MBTS is present at 1 phr to 2 phr and stearic acid is present at 0.1 phr to 1 phr.

Metal oxides can act as curing agents in the curing system. Examples of metal oxides include, but are not limited to, zinc oxide, calcium oxide, lead oxide, magnesium oxide, and combinations thereof. When included, the one or more metal oxide can be present individually at 0.01 phr to 5.0 phr, or 0.1 phr to 4 phr, or 1 phr to 3 phr, or 0.01 phr to 0.5 phr, or 2 phr to 4 phr.

The metal oxide can be used alone or in conjunction with its corresponding metal fatty acid complex (e.g., zinc stearate, calcium stearate, etc.), or with the organic and fatty acids added alone, such as stearic acid, and optionally other curatives such as sulfur or a sulfur compound, an alkylperoxide compound, diamines, or derivatives thereof.

### Other Additives

The elastomeric compositions and blends thereof described herein may also contain other conventional additives such as fillers, dyes, pigments, antioxidants, heat and light stabilizers, plasticizers, oils, and other ingredients as known in the art.

Optionally, one or more fillers can be included in the elastomeric compositions and blends thereof described herein. Examples of fillers include, but are not limited to, calcium carbonate, clay, mica, silica, silicates, talc, titanium dioxide, aluminum oxide, starch, wood flour, carbon black (e.g., N110 to N990 per ASTM D1765-17), or combinations thereof. The fillers may be any size and typically range, for example, in the tire industry, from about 0.0001 μm to about 100 μm. When included, fillers can be present individually at 10 phr to 100 phr, or 25 phr to 80 phr, or 30 phr to 70 phr.

For example in tire bladder formulations, high structure carbon black ISAF (e.g., N220 per ASTM D1765-17) or HAF (e.g., N330 per ASTM D1765-17) can give a good balance of properties and can be used in bladder compounds at levels of 40 phr to 60 phr. Other alternative types of carbon black are the GPF grades which show improved air aging, though ISAF grades have better steam aging properties. Acetylene black compounds in combination with, for example, N330 have good thermal conductivity which may reduce tire curing time. However, acetylene black may be difficult to disperse in the butyl rubber compound. Generally, a lower loading of carbon black (e.g., 35 phr) gives better air aging and higher loading of carbon black (e.g., 65 phr) gives better steam aging.

As used herein, silica is meant to refer to any type or particle size silica or another silicic acid derivative, or silicic acid, processed by solution, pyrogenic, or like methods, including untreated, precipitated silica, crystalline silica, colloidal silica, aluminum or calcium silicates, fumed silica, and the like. Precipitated silica can be conventional silica, semi-highly dispersible silica, or highly dispersible silica.

The elastomeric composition may also include clay as a filler. The clay may be, for example, montmorillonite, nontronite, beidellite, vokoskoite, laponite, hectorite, saponite, sauconite, magadite, kenyaite, stevensite, vermiculite, halloysite, aluminate oxides, hydrotalcite, or mixtures thereof, optionally, treated with modifying agents. The clay may contain at least one silicate. Alternatively, the filler may be a layered clay, optionally, treated or pre-treated with a modifying agent such as organic molecules; the layered clay may comprise at least one silicate.

Depending on the equipment, resin cure bladder compounds may be difficult to mix and process. To facilitate good dispersion and flow properties, it may be beneficial to use process aids such as organosilicone compounds. There are several commercially available process aids such as organosilicones and calcium fatty acid soaps suitable for curing bladder compounds.

Blending of the fillers, additives, and/or curing system components may be carried out by combining the desired components and the elastomers described herein in any suitable mixing device such as a BANBURY™ mixer, BRABENDER™ mixer or preferably a mixer/extruder and mixing at temperatures in the range of 120° C. up to 300° C. under conditions of shear sufficient to allow the components to become uniformly dispersed within the elastomer to form the elastomeric compositions and blends thereof described herein.

Blends with Butyl Rubber

The brominated isobutylene paramethyl-styrene elastomer compositions described herein can also be optionally blended with butyl rubbers (e.g., isobutylene-isoprene copolymers). Preferably, isobutylene-isoprene copolymers have 0.5 mol % to 3 mol % isoprene with the balance being isobutylene. Examples of isobutylene-isoprene copolymers, include but are not limited to, EXXON™ BUTYL 065, EXXON™ BUTYL 065S, EXXON™ BUTYL 365, EXXON™ BUTYL 068, EXXON™ BUTYL 068S, EXXON™ BUTYL 268, EXXON™ BUTYL 268S, and combinations thereof.

When included, the butyl rubber can be included in blends with the brominated isobutylene paramethyl-styrene elastomer compositions (and optionally the additional additives) at 0.5 phr to 30 phr, or 1 phr to 25 phr, or 5 phr to 20 phr, or 10 phr to 15 phr.

### Methods

The brominated isobutylene paramethyl-styrene elastomer compositions and blends thereof described herein may be compounded (mixed) by any conventional means known to those skilled in the art. The mixing may occur in a single step or in multiple stages. For example, the ingredients are typically mixed in at least two stages, namely at least one non-productive stage followed by a productive mixing stage. The final curatives are typically mixed in the final stage, which is conventionally called the “productive” mix stage. In the productive mix stage, the mixing typically occurs at a temperature, or ultimate temperature, lower than the mix temperature(s) of the preceding non-productive mix stage(s). The elastomers, butyl rubber, polymer additives, silica and silica coupler, and carbon black, if used, are generally mixed in one or more non-productive mix stages. The terms “non-productive” and “productive” mix stages are well known to those having skill in the rubber mixing art.

In one embodiment, the carbon black is added in a different stage from zinc oxide and other cure activators and accelerators. In another embodiment, antioxidants, antiozonants, and processing materials are added in a stage after the carbon black has been processed with the elastomers, and zinc oxide is added at a final stage to maximize the compound modulus. In a further embodiment, mixing with the clays are performed by techniques known to those skilled in the art, wherein the clay is added to the polymer at the same time as the carbon black. In other embodiments, additional stages may involve incremental additions of one or more fillers.

In another embodiment, mixing of the components may be carried out by combining the elastomer components, filler and clay in any suitable mixing device such as a two-roll open mill, BRABENDER™ internal mixer, BANBURY™ internal mixer with tangential rotors, Krupp internal mixer with intermeshing rotors, or preferably a mixer/extruder, by techniques known in the art. Mixing may be performed at temperatures up to the melting point of the elastomer(s) used in the composition in one embodiment, or from 40° C. to 250° C., or from 100° C. to 200° C. Mixing should generally be conducted under conditions of shear sufficient to allow any clay to exfoliate and become uniformly dispersed within the elastomer(s).

Typically, from 70% to 100% of the elastomer or elastomers is first mixed for 20 to 90 seconds, or until the temperature reaches from 40° C. to 75° C. Then, approximately 75% of the filler, and the remaining amount of elastomer, if any, are typically added to the mixer, and mixing continues until the temperature reaches from 90° C. to 150° C. Next, the remaining filler is added, as well as the processing aids, and mixing continues until the temperature reaches from 140° C. to 190° C. The masterbatch mixture is then finished by sheeting on an open mill and allowed to cool, for example, to from 60° C. to 100° C. when the remaining components of the curing system may be added to produce a final batch mix.

The curing bladder is a cylindrical bag usually made from the final batch mix. Generally, the final batch mix is molded into the shape of a tire curing bladder and cured. Advantageously, the brominated isobutylene paramethyl-styrene elastomer compositions and blends thereof described herein have reduced curing times and/or temperatures as compared to the butyl rubber compositions currently used to make tire curing bladders. That is, a typical curing cycle for butyl rubber compositions is 45 min to 1 hr at 185° C. to 200° C. In contrast, the elastomeric compositions and blends thereof described herein can, for example, be cured at less than 30 min (e.g., 15 min to 30 min, or 20 min to 25 min) at 170° C. to 200° C. In another example, the curing time can be 45 min to 90 min (e.g., 50 min to 80 min, or 60 min to 70 min), and the curing temperature can be 120° C. to 150° C. (e.g., 125° C. to 145° C., or 130° C. to 140° C.).

Generally, with lower temperatures longer curing times are needed. As described, the curing temperature as compared to butyl rubber compositions can be about the same, but the curing time can be reduced by at least half. Alternatively, the curing time can be the same to a bit longer and be at a lower temperature. In either instance, energy costs are reduced.

In use, this collapsible bladder is mounted in the lower section of the tire curing press and forms a part of the press and mold assembly. The “green” unvulcanized tire is positioned over the bladder in the bottom half of the mold. When the mold is closed, pressurized steam, air, hot water, or inert gas (nitrogen) is introduced systematically (pre-programmed) into the bladder to provide internal heat and pressure for the tire shaping and curing process. Two typical types of tire curing presses that require bladders are: (1) SLIDEBACK™ (tire curing press and loader, available from NRM) type press that requires an AUTOFORM™ (mechanical tire press, available from Bagwell) bladder and (2) TILTBACK™ (mechanical tire press, available from Bag-O-Matic) type press that requires a Bag-O-Matic bladder. Examples of tire curing bladders include wall curing bladders for passenger cars, light trucks and commercial trucks, toroidal curing bladders, closed end curing bladders, and the like.

Three types of tire cure cycles can be found, a steam-high pressure hot water cure cycle, a steam-inert gas cure process, and a steam-steam cure cycle. Dome temperatures can reach 190° C. (mold sidewall plates at 180° C.), and the bladder temperatures can reach up to 220° C. An exemplary simple steam-hot water cure cycle time for a truck tire might be (1) steam 12 minutes; (2) high pressure hot water 30 minutes; (3) cold water flush 4 minutes; and (4) drain 30 seconds, for a total cure time of 46:30. The elastomeric compositions and blends thereof described herein can be used for the curing bladder since they generally meet the basic property requirements: (1) a homogeneous, well mixed compound for ease of processing (mixing, extruding, and mold flow); (2) excellent heat aging resistance; (3) resistance to degradation due to saturated steam or high pressure hot water, or inert gas; (4) excellent flex and hot tear resistance; (5) low tension and compression set that maintains high elongation properties; and (6) impermeability to air, inert gas, and water vapor. Attainment of these properties enables a curing bladder to achieve an adequate service life (i.e., number of tire cure cycles), which is commonly referred to as the pull-point. The pull-point is where the bladder is removed before failure; thereby preventing failures during tire cure cycles, which can lead to the loss of tires during production. As compared to tire bladders composed of butyl rubber compositions, the tire bladders comprising the brominated isobutylene paramethyl-styrene elastomer compositions and blends thereof described herein can have an increased pull-point.

### Composition Properties

The brominated isobutylene paramethyl-styrene elastomer compositions and blends thereof described herein after curing can have an improved air impermeability, such as having an oxygen transmission rate of 0.300 (mm)·(cc)/[m²·day·mmHg] at 40° C. or lower as measured on compositions or articles as described herein, or 0.250 (mm)·(cc)/[m²·day·mmHg] at 40° C. or lower, or 0.220 (mm)·(cc)/[m²·day·mmHg] at 40° C. or lower, or 0.210 (mm)·(cc)/[m²·day·mmHg] at 40° C. or lower, or 0.200 (mm)·(cc)/[m²·day·mmHg] at 40° C. or lower. For example, the elastomeric compositions and blends thereof described herein formed into articles like tire bladders can have an oxygen transmission rate of 0.150 to 0.300 (mm)·(cc)/[m²·day˜mmHg] at 40° C., or 0.155 to 0.250 (mm)·(cc)/[m²·day·mmHg] at 40° C., or 0.160 to 0.200 (mm)·(cc)/[m²·day·mmHg] at 40° C. as measured on compositions or articles as described herein. Oxygen transmission rate can be tested using ASTM D 3985-05 and an OX-TRAN® 2/61 MJ module (an oxygen transmission rate test system, available from Mocon, Inc.).

The brominated isobutylene paramethyl-styrene elastomer compositions and blends thereof described herein can have an improved Mooney Viscosity (ML, 1+4 @ 100° C.), which can range from 75 to 92, or 77 to 90, or 80 to 88. Mooney Viscosity (ML, 1+4 @ 100° C.) can be measured as described above.

The brominated isobutylene paramethyl-styrene elastomer compositions and blends thereof described herein can have an improved Shore A Hardness, which is measured by ASTM D2240-15e1. An improvement in Shore A Hardness is a reduction in hardness, which increases the lifetime of the elastomeric compositions and articles like tire bladders produced therefrom. The elastomeric compositions and blends thereof described herein after curing at 190° C. for an amount of time to reach 90% cure plus 2 minutes using a moving die rheometer (tc90+2 @ 190° C. MDR) can have a Shore A Hardness of 50 or less, 55 to 60, or 55 to 58. The elastomeric compositions and blends thereof described herein after tc90+2 @ 190° C. MDR curing and aging two days in air at 177° C. can have a Shore A Hardness of 80 or less, 70 to 80, or 72 to 76. The elastomeric compositions and blends thereof described herein after tc90+2 @ 190° C. MDR curing and aging three days in steam at 170° C. can have a Shore A Hardness of 65 or less, 50 to 65, or 55 to 70.

The brominated isobutylene paramethyl-styrene elastomer compositions and blends thereof described herein can have an improved tear resistance retention, which also increases the lifetime of the elastomeric compositions and articles like tire bladders produced therefrom. Tear resistance can be measured by a die c tear test of ASTM D624-00(2012). When measured after curing tc90+2 @ 190° C. MDR curing and then after aging, a comparison of these numbers (after curing and aging divided by after only curing) provides a tear resistance retention, which is a percentage. The elastomeric compositions and blends thereof described herein can have a tear resistance retention based on tear resistance after curing and aging two days in air at 177° C. divided by tear resistance after curing of 100% to 135%, or 110% to 130%.

The brominated isobutylene paramethyl-styrene elastomer compositions and blends thereof described herein can have an improved modulus at 100% elongation (modulus at 100%). For example, the elastomeric compositions and blends thereof described herein after tc90+2 @ 190° C. MDR curing can have a modulus at 100% of 1.2 MPa to 2.5 MPa, or 1.5 MPa to 2.2 MPa, or 1.8 MPa to 2.0 MPa. In another example, the elastomeric compositions and blends thereof described herein after tc90+2 @ 190° C. MDR curing and aging in air at 177° C. for 2 days can have a modulus at 100% of 2.5 MPa to 4.0 MPa, or 2.9 MPa to 3.8 MPa, or 3.2 MPa to 3.6 MPa. In yet another example, the elastomeric compositions and blends thereof described herein after tc90+2 @ 190° C. MDR curing and aging in steam at 170° C. for 3 days can have a modulus at 100% of 1.5 MPa to 2.5 MPa, or 1.7 MPa to 2.3 MPa, or 1.9 MPa to 2.1 MPa. Modulus at 100% can be measured by ASTM D412-16.

The brominated isobutylene paramethyl-styrene elastomer compositions and blends thereof described herein can have an improved modulus at 300% elongation (modulus at 300%). For example, the elastomeric compositions and blends thereof described herein after tc90+2 @ 190° C. MDR curing can have a modulus at 300% of 4.5 MPa to 11.5 MPa, or 6.0 MPa to 11.0 MPa, or 8.0 MPa to 10.5 MPa. In another example, the elastomeric compositions and blends thereof described herein after tc90+2 @ 190° C. MDR curing and aging in air at 177° C. for 2 days can have a modulus at 300% of 8.0 MPa to 13.5 MPa, or 9.0 MPa to 13.0 MPa, or 9.5 MPa to 12.5 MPa. In yet another example, the elastomeric compositions and blends thereof described herein after tc90+2 @ 190° C. MDR curing and aging in steam at 170° C. for 3 days can have a modulus at 300% of 6.5 MPa to 12.5 MPa, or 8.0 MPa to 12.0 MPa, or 9.0 MPa to 11.5 MPa. Modulus at 300% can be measured by ASTM D412-16.

The brominated isobutylene paramethyl-styrene elastomer compositions and blends thereof described herein can have an improved tensile strength at break. For example, the elastomeric compositions and blends thereof described herein after tc90+2 @ 190° C. MDR curing can have a tensile strength at break of 11.0 MPa to 17.0 MPa, or 13.0 MPa to 16.5 MPa, or 14.7 MPa to 16.0 MPa. In another example, the elastomeric compositions and blends thereof described herein after tc90+2 @ 190° C. MDR curing and aging in air at 177° C. for 2 days can have a tensile strength at break of 12.0 MPa to 17.0 MPa, or 12.5 MPa to 16.5 MPa, or 13.0 MPa to 16.0 MPa. In yet another example, the elastomeric compositions and blends thereof described herein after tc90+2 @ 190° C. MDR curing and aging in steam at 170° C. for 3 days can have a tensile strength at break of 9.0 MPa to 17.0 MPa, or 12.0 MPa to 16.5 MPa, or 14.0 MPa to 16.0 MPa. Tensile strength at break can be measured by ASTM D412-16.

The brominated isobutylene paramethyl-styrene elastomer compositions and blends thereof described herein can have an improved elongation to break. For example, the elastomeric compositions and blends thereof described herein after tc90+2 @ 190° C. MDR curing can have an elongation to break of 400% to 800%, or 600% to 775%, or 700% to 750%. In another example, the elastomeric compositions and blends thereof described herein after tc90+2 @ 190° C. MDR curing and aging in air at 177° C. for 2 days can have an elongation to break of 300% to 550%, or 350% to 525%, or 400% to 500%. In yet another example, the elastomeric compositions and blends thereof described herein after tc90+2 @ 190° C. MDR curing and aging in steam at 170° C. for 3 days can have an elongation to break of 350% to 500%, or 375% to 475%, or 400% to 450%. Elongation to break can be measured by ASTM D412-16.

### Example Embodiments

Example 1. A composition comprising: an elastomeric composition formed into a curing bladder, the elastomeric composition comprising: 100 parts per hundred parts rubber (phr) of an elastomer comprising a C₄-C₇ isoolefin, a non-halogenated alkylstyrene, and a halogenated alkylstyrene; 1 phr to 7.5 phr alkyl phenol formaldehyde resin; and 0.5 phr to 5 phr mercaptobenzothiazole disulfide.

Example 2. The composition of Example 1, wherein the alkyl phenol formaldehyde resin comprises octyl phenol formaldehyde resin and/or brominated octyl phenol formaldehyde resin.

Example 3. The composition of any preceding Example, wherein the alkyl phenol formaldehyde resin is present at about 3 phr to about 5 phr.

Example 4. The composition of any preceding Example, wherein the mercaptobenzothiazole disulfide is present at 1.4 phr to about 2.0 phr.

Example 5. The composition of any preceding Example, wherein the C₄-C₇ isoolefin comprises isobutylene.

Example 6. The composition of any preceding Example, wherein the non-halogenated alkylstyrene comprises paramethylstyrene.

Example 7. The curing bladder of any preceding Example, wherein the halogenated alkylstyrene comprises brominated paramethylstyrene.

Example 8. The composition of any preceding Example, wherein the non-halogenated alkylstyrene and the halogenated alkylstyrene cumulatively are present in the elastomer composition in the amount of greater than or equal to about 10 wt % based on the elastomer composition.

Example 9. The composition of any preceding Example, wherein the halogenated alkylstyrene is present at from 0.1 mol % to 7.5 mol % relative to the non-halogenated alkylstyrene.

Example 10. The composition of any preceding claim, wherein the C₄-C₇ isoolefin is present in the elastomer composition in the amount of less than or equal to about 90 wt % based on the elastomer composition.

Example 11. The composition of any preceding Example further comprising a processing aid and a filler.

Example 12. The composition of Example 11, wherein the filler comprises carbon black.

Example 13. The composition of Example 11 or 12, wherein the filler comprises clay.

Example 14. The composition of any preceding Example, wherein the elastomeric composition further comprises 0.5 phr to 30 phr butyl rubber.

Example 15. A method of making a tire curing bladder comprising: mixing 100 parts per hundred parts rubber (phr) of an elastomer composition comprising a C₄-C₇ isoolefin, a non-halogenated alkylstyrene, and a halogenated alkylstyrene, 1 phr to 7.5 phr alkyl phenol formaldehyde resin, and 0.5 phr to 5 phr mercaptobenzothiazole disulfide; and molding and curing the mixture into the shape of a tire curing bladder.

Example 16. The method of Example 15, wherein curing is for less than 30 minutes at about 170° C. to about 200° C.

Example 17. The method of Example 15, wherein curing is for less about 45 minutes to about 90 minutes at about 120° C. to about 150° C.

Example 18. The method of one of Example 15-17, wherein the alkyl phenol formaldehyde resin comprises octyl phenol formaldehyde resin and/or brominated octyl phenol formaldehyde resin.

Example 19. The method of one of Example 15-18, wherein the alkyl phenol formaldehyde resin is present at about 3 phr to about 5 phr.

Example 20. The method of one of Example 15-19, wherein the mercaptobenzothiazole disulfide is present at 1.4 phr to about 2.0 phr.

Example 21. The method of one of Example 15-20, wherein the C₄-C₇ isoolefin comprises isobutylene.

Example 22. The method of one of Example 15-21, wherein the non-halogenated alkylstyrene comprises paramethylstyrene.

Example 23. The method of one of Example 15-22, wherein the halogenated alkylstyrene comprises brominated paramethylstyrene.

Example 24. The method of one of Example 15-23 further comprising a processing aid and a filler.

Example 25. The method of one of Example 15-24, wherein the elastomeric composition further comprises 0.5 phr to 30 phr butyl rubber.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

Ten samples were prepared according to the formulations in Table 1 and the mixing parameters in Table 2 below. Sample 1 is a control sample using butyl rubber, specifically 100 phr EXXON™ Butyl 268S rubber (butyl rubber, available from ExxonMobil Chemical Company, Houston Tex.) and 5 phr chloroprene rubber (available from Skyprene B30) (available from Tosoh Corporation). Samples 2-10 are elastomeric compositions of the present disclosure using 100 phr EXXPRO™ 3035 (available from ExxonMobil Chemical Company, Houston Tex.). In samples 2-10, the curing system was varied by changing the concentrations of octyl phenol formaldehyde resin and MBTS.

As illustrated in Table 1, using the elastomeric compositions described herein (Samples 2-10) use less zinc oxide and less octyl phenol formaldehyde resin and no chloroprene rubber. Chloroprene rubber is a specialty chemical, and octyl phenol formaldehyde resin is a chemical with a short shelf life that requires special procedures for handling. Reduction or elimination of these chemical reduces the cost of the formulation and makes the formulation easier to produce.

TABLE 1
Sample formulations

| | | | | | | | | | | |
|---|---|---|---|---|---|---|---|---|---|---|
| Sample No. | 1 | 2 | 3 | 4 | 5 | 6 | 7 | 8 | 9 | 10 |

Master Batch (MB) Components

| | | | | | | | | | | |
|---|---|---|---|---|---|---|---|---|---|---|
| Chloroprene | 5.0 | — | — | — | — | — | — | — | — | — |
| rubber (phr) | | | | | | | | | | |
| Castor oil (phr) | 5.0 | 5.0 | 5.0 | 5.0 | 5.0 | 5.0 | 5.0 | 5.0 | 5.0 | 5.0 |
| Stearic acid (phr) | 1.0 | 0.5 | 0.5 | 0.5 | 0.5 | 0.5 | 0.5 | 0.5 | 0.5 | 0.5 |
| EXXON ™ | 100.0 | — | — | — | — | — | — | — | — | — |
| Butyl 268 S | | | | | | | | | | |
| rubber (phr) | | | | | | | | | | |
| N330(HAF)- | 50.0 | 50.0 | 50.0 | 50.0 | 50.0 | 50.0 | 50.0 | 50.0 | 50.0 | 50.0 |
| carbon black (phr) | | | | | | | | | | |
| EXXON ™ | — | 100.0 | 100.0 | 100.0 | 100.0 | 100.0 | 100.0 | 100.0 | 100.0 | 100.0 |
| 3035 (phr) | | | | | | | | | | |
| Total MB phr | 161.0 | 155.5 | 155.5 | 155.5 | 155.5 | 155.5 | 155.5 | 155.5 | 155.5 | 155.5 |

Final Batch (FB) Components

| | | | | | | | | | | |
|---|---|---|---|---|---|---|---|---|---|---|
| MB (phr) | 161.0 | 155.5 | 155.5 | 155.5 | 155.5 | 155.5 | 155.5 | 155.5 | 155.5 | 155.5 |
| Zinc oxide (phr) | 5.0 | 3.0 | 3.0 | 3.0 | 3.0 | 3.0 | 3.0 | 3.0 | 3.0 | 3.0 |
| RESIN SP-1045 | 10.0 | 1.5 | 1.5 | 1.5 | 3.0 | 3.0 | 3.0 | 5.0 | 5.0 | 5.0 |
| (octyl phenol | | | | | | | | | | |
| formaldehyde | | | | | | | | | | |
| resin) (phr) | | | | | | | | | | |
| MgO (phr) | — | 0.1 | 0.1 | 0.1 | 0.1 | 0.1 | 0.1 | 0.1 | 0.1 | 0.1 |
| MBTS (phr) | — | 0.8 | 1.4 | 2.0 | 0.8 | 1.4 | 2.0 | 0.8 | 1.4 | 2.0 |
| Total FB lab | 176.0 | 160.9 | 161.5 | 162.1 | 162.4 | 163.0 | 163.6 | 164.4 | 165.0 | 165.6 |

TABLE 2
Mixing parameters

| Sample | | | | | | | | | | |
|---|---|---|---|---|---|---|---|---|---|---|
| No. | 1 | 2 | 3 | 4 | 5 | 6 | 7 | 8 | 9 | 10 |

Master Batch Mixing (Mixer: 1.57 L BANBURY ™)

| | | | | | | | | | | |
|---|---|---|---|---|---|---|---|---|---|---|
| Start | 54.0 | 51.0 | 52.0 | 54.0 | 50.0 | 50.0 | 50.0 | 51.0 | 51.0 | 52.0 |
| temp | | | | | | | | | | |
| [° C.] | | | | | | | | | | |
| Dump | 163.0 | 165.0 | 165.0 | 165.0 | 163.0 | 165.0 | 165.0 | 163.0 | 162.0 | 165.0 |
| Temp | | | | | | | | | | |
| [° C.] | | | | | | | | | | |
| Mixing | 7:00 | 7:10 | 7:00 | 7:00 | 7:00 | 7:00 | 7:00 | 7:00 | 7:00 | 7:00 |
| Time | | | | | | | | | | |
| [min:sec] | | | | | | | | | | |
| Rotor | 77.0 | 77.0 | 77.0 | 77.0 | 77.0 | 77.0 | 77.0 | 77.0 | 77.0 | 77.0 |
| Speed | | | | | | | | | | |
| [RPM] | | | | | | | | | | |
| Actual | 1433.8 | 1431.5 | 1434.6 | 1435.4 | 1436.1 | 1433.6 | 1434.2 | 1432.4 | 1433.4 | 1433.9 |
| Weight | | | | | | | | | | |
| [g] | | | | | | | | | | |

Final Batch Mixing (Mixer: 1.57 L BANBURY ™)

| | | | | | | | | | | |
|---|---|---|---|---|---|---|---|---|---|---|
| Start | 42.0 | 42.0 | 43.0 | 39.0 | 39.0 | 40.0 | 42.0 | 42.0 | 43.0 | 44.0 |
| temp | | | | | | | | | | |
| [° C.] | | | | | | | | | | |
| Dump | 100.0 | 98.0 | 101.0 | 97.0 | 100.0 | 101.0 | 100.0 | 93.0 | 101.0 | 95.0 |
| Temp | | | | | | | | | | |
| [° C.] | | | | | | | | | | |
| Mixing | 2:30 | 2:30 | 2:30 | 2:30 | 2:30 | 2:30 | 2:30 | 2:30 | 2:30 | 2:30 |
| Time | | | | | | | | | | |
| [min:sec] | | | | | | | | | | |
| Rotor | 40.0 | 40.0 | 40.0 | 40.0 | 40.0 | 40.0 | 40.0 | 40.0 | 40.0 | 40.0 |
| Speed | | | | | | | | | | |
| [RPM] | | | | | | | | | | |
| Actual | 1371.8 | 1381.7 | 1379.2 | 1381.1 | 1377.0 | 1379.3 | 1375.3 | 1379.5 | 1376.3 | 1377.8 |
| Weight | | | | | | | | | | |
| [g] | | | | | | | | | | |

Various properties of the ten samples were measured, see Tables 3-7. Table 3 provides the Mooney viscosity and Mooney scorch properties of the ten samples. This data illustrates that as compared to the control (Sample 1), the elastomeric compositions of the present disclosure (Samples 2-10) have increased ML(1+4) and decreased t5 while maintaining a consistent density.

TABLE 3
Mooney viscosity and Mooney scorch properties

| | | | | | | | | | | |
|---|---|---|---|---|---|---|---|---|---|---|
| Sample No. | 1 | 2 | 3 | 4 | 5 | 6 | 7 | 8 | 9 | 10 |

Mooney ML(1 + 4) on MV2000; ASTM 1646-17

| | | | | | | | | | | |
|---|---|---|---|---|---|---|---|---|---|---|
| Test temp | 100 | 100 | 100 | 100 | 100 | 100 | 100 | 100 | 100 | 100 |
| [° C.] | | | | | | | | | | |
| Test time | 4 | 4 | 4 | 4 | 4 | 4 | 4 | 4 | 4 | 4 |
| [min] | | | | | | | | | | |
| Preheat | 1 | 1 | 1 | 1 | 1 | 1 | 1 | 1 | 1 | 1 |
| [min] | | | | | | | | | | |
| Initial [MU] | 99 | 117 | 119 | 116 | 114 | 116 | 115 | 113 | 112 | 112 |
| ML(1 + 4) | 73 | 86 | 88 | 88 | 84 | 85 | 86 | 81 | 80 | 81 |
| [MU] | | | | | | | | | | |

Mooney Scorch on MV2000; ASTM 1646-17

| | | | | | | | | | | |
|---|---|---|---|---|---|---|---|---|---|---|
| Test temp | 150 | 150 | 150 | 150 | 150 | 150 | 150 | 150 | 150 | 150 |
| [° C.] | | | | | | | | | | |
| Test time | 60 | 60 | 60 | 60 | 60 | 60 | 60 | 60 | 60 | 60 |
| [min] | | | | | | | | | | |
| Preheat | 1 | 1 | 1 | 1 | 1 | 1 | 1 | 1 | 1 | 1 |
| [min] | | | | | | | | | | |
| Mm [MU] | 50.2 | 56.8 | 57.7 | 57.2 | 55.5 | 55.3 | 55.4 | 53.8 | 52.2 | 52.2 |
| tMm [min] | 5.3 | 3.5 | 3.6 | 3.9 | 3.8 | 3.4 | 3.7 | 3.6 | 4.1 | 4.3 |
| t1 [min] | 8.4 | 4.6 | 4.6 | 4.9 | 4.9 | 4.8 | 5.3 | 5.0 | 5.4 | 5.8 |
| t2 [min] | 10.4 | 5.5 | 5.4 | 5.7 | 5.8 | 5.9 | 6.4 | 6.0 | 6.6 | 6.9 |
| t3 [min] | 12.3 | 6.4 | 6.3 | 6.6 | 6.7 | 7.1 | 7.7 | 6.8 | 7.4 | 7.8 |
| t5 [min] | 15.4 | 8.4 | 9.5 | 9.6 | 8.1 | 9.1 | 9.5 | 8.0 | 8.4 | 8.9 |
| t10 [min] | 21.5 | 12.1 | 13.4 | 13.9 | 10.4 | 10.9 | 11.3 | 9.9 | 9.8 | 10.1 |
| t20 [min] | 26.3 | 14.7 | 15.0 | 15.7 | 13.1 | 12.1 | 12.3 | 12.0 | 11.1 | 11.0 |
| t35 [min] | 29.3 | 17.6 | 15.9 | 16.6 | 15.5 | 13.1 | 12.9 | 13.8 | 12.3 | 11.7 |

Density Measurement; ASTM D297-15
Cure Condition: tc90 + 2 @ 190° C. MDR

| | | | | | | | | | | |
|---|---|---|---|---|---|---|---|---|---|---|
| Density | 1.119 | 1.120 | 1.118 | 1.121 | 1.117 | 1.119 | 1.121 | 1.118 | 1.117 | 1.118 |
| [gm/cc] | | | | | | | | | | |

Table 4 provides the rheological properties of the ten samples at three different temperatures. This data illustrates that the cure time (t90) for the control samples is two to three times the cure time for the elastomeric compositions of the present disclosure (Samples 2-10).

TABLE 4
Rheology properties at three different temperatures

| | | | | | | | | | | |
|---|---|---|---|---|---|---|---|---|---|---|
| Sample No. | 1 | 2 | 3 | 4 | 5 | 6 | 7 | 8 | 9 | 10 |

MDR by MDR 2000; ASTM 5289-17

| | | | | | | | | | | |
|---|---|---|---|---|---|---|---|---|---|---|
| Test Time [min] | 60 | 60 | 60 | 60 | 60 | 60 | 60 | 60 | 60 | 60 |
| Test Temp [° C.] | 170 | 170 | 170 | 170 | 170 | 170 | 170 | 170 | 170 | 170 |
| Osc. angle [deg.] | 0.5 | 0.5 | 0.5 | 0.5 | 0.5 | 0.5 | 0.5 | 0.5 | 0.5 | 0.5 |
| ML [dNm] | 2.3 | 2.7 | 2.7 | 2.7 | 2.6 | 2.6 | 2.6 | 2.5 | 2.5 | 2.5 |
| MH [dNm] | 9.8 | 10.5 | 8.7 | 7.3 | 11.3 | 9.7 | 8.3 | 11.0 | 9.9 | 8.2 |
| MH-ML [dNm] | 7.5 | 7.9 | 6.0 | 4.7 | 8.8 | 7.1 | 5.7 | 8.5 | 7.5 | 5.8 |
| ts1 [min] | 3.4 | 2.9 | 3.2 | 3.2 | 2.6 | 2.7 | 2.8 | 2.6 | 2.5 | 2.7 |
| ts2 [min] | 7.1 | 4.8 | 4.6 | 4.7 | 4.2 | 3.8 | 3.6 | 4.1 | 3.5 | 3.6 |
| t10 [min] | 2.6 | 2.3 | 1.7 | 1.3 | 2.3 | 2.2 | 1.7 | 2.3 | 2.1 | 2.1 |
| t20 [min] | 5.2 | 4.1 | 3.6 | 2.9 | 3.8 | 3.2 | 2.9 | 3.6 | 3.0 | 2.8 |
| t30 [min] | 8.1 | 5.6 | 4.3 | 4.1 | 5.3 | 3.9 | 3.4 | 4.9 | 3.7 | 3.3 |
| t40 [min] | 11.4 | 7.4 | 5.0 | 4.6 | 6.8 | 4.8 | 3.8 | 6.3 | 4.5 | 3.9 |
| t50 [min] | 15.2 | 9.4 | 6.0 | 5.1 | 8.6 | 5.7 | 4.4 | 7.8 | 5.3 | 4.5 |
| t60 [min] | 19.8 | 11.9 | 7.4 | 5.7 | 10.7 | 6.9 | 5.3 | 9.6 | 6.2 | 5.3 |
| t70 [min] | 25.6 | 15.1 | 9.4 | 6.5 | 13.4 | 8.4 | 6.6 | 12.0 | 7.4 | 6.4 |
| t80 [min] | 33.1 | 19.9 | 13.0 | 8.3 | 17.6 | 10.9 | 9.9 | 15.4 | 9.3 | 8.7 |
| t90 [min] | 43.7 | 28.6 | 21.4 | 15.7 | 25.7 | 18.0 | 22.4 | 22.1 | 13.7 | 21.3 |

MDR by MDR 2000; ASTM 5289-17

| | | | | | | | | | | |
|---|---|---|---|---|---|---|---|---|---|---|
| Test Time [min] | 60 | 60 | 60 | 60 | 60 | 60 | 60 | 60 | 60 | 60 |
| Test Temp [° C.] | 180 | 180 | 180 | 180 | 180 | 180 | 180 | 180 | 180 | 180 |
| Osc. angle [deg.] | 0.5 | 0.5 | 0.5 | 0.5 | 0.5 | 0.5 | 0.5 | 0.5 | 0.5 | 0.5 |
| ML [dNm] | 2.2 | 2.4 | 2.5 | 2.4 | 2.4 | 2.4 | 2.4 | 2.2 | 2.2 | 2.2 |
| MH [dNm] | 10.0 | 10.1 | 8.5 | 7.0 | 11.0 | 9.4 | 8.2 | 10.5 | 8.9 | 8.3 |
| MH-ML [dNm] | 7.8 | 7.7 | 6.0 | 4.6 | 8.6 | 7.0 | 5.7 | 8.3 | 6.7 | 6.0 |
| ts1 [min] | 2.6 | 2.0 | 2.1 | 2.2 | 1.7 | 1.8 | 1.8 | 1.8 | 1.7 | 1.7 |
| ts2 [min] | 5.0 | 3.1 | 2.8 | 2.9 | 2.7 | 2.4 | 2.2 | 2.6 | 2.3 | 2.2 |
| t10 [min] | 2.1 | 1.7 | 1.3 | 1.0 | 1.5 | 1.5 | 1.4 | 1.6 | 1.5 | 1.4 |
| t20 [min] | 4.0 | 2.6 | 2.3 | 2.1 | 2.4 | 2.1 | 1.9 | 2.3 | 2.0 | 1.8 |
| t30 [min] | 5.9 | 3.4 | 2.7 | 2.5 | 3.3 | 2.5 | 2.1 | 3.0 | 2.3 | 2.1 |
| t40 [min] | 8.1 | 4.4 | 3.1 | 2.8 | 4.1 | 2.9 | 2.4 | 3.7 | 2.7 | 2.4 |
| t50 [min] | 10.7 | 5.4 | 3.7 | 3.1 | 5.0 | 3.5 | 2.8 | 4.4 | 3.1 | 2.7 |
| t60 [min] | 14.0 | 6.7 | 4.5 | 3.5 | 6.2 | 4.1 | 3.3 | 5.3 | 3.6 | 3.2 |
| t70 [min] | 18.4 | 8.3 | 5.8 | 4.1 | 7.7 | 5.0 | 4.4 | 6.5 | 4.3 | 4.0 |
| t80 [min] | 24.9 | 10.9 | 8.1 | 5.8 | 9.9 | 6.7 | 7.2 | 8.2 | 5.3 | 6.5 |
| t90 [min] | 35.2 | 16.1 | 15.6 | 18.7 | 14.6 | 13.5 | 18.5 | 11.7 | 8.3 | 20.1 |

MDR by MDR 2000; ASTM 5289-17

| | | | | | | | | | | |
|---|---|---|---|---|---|---|---|---|---|---|
| Test Time [min] | 60 | 60 | 60 | 60 | 60 | 60 | 60 | 60 | 60 | 60 |
| Test Temp [° C.] | 190 | 190 | 190 | 190 | 190 | 190 | 190 | 190 | 190 | 190 |
| Osc. angle [deg.] | 0.5 | 0.5 | 0.5 | 0.5 | 0.5 | 0.5 | 0.5 | 0.5 | 0.5 | 0.5 |
| ML [dNm] | 2.1 | 2.3 | 2.3 | 2.3 | 2.2 | 2.3 | 2.2 | 2.1 | 2.1 | 2.1 |
| MH [dNm] | 10.9 | 9.6 | 8.2 | 6.8 | 10.4 | 9.1 | 7.8 | 10.1 | 8.9 | 7.9 |
| MH-ML [dNm] | 8.8 | 7.4 | 5.9 | 4.5 | 8.2 | 6.8 | 5.6 | 8.0 | 6.9 | 5.8 |
| ts1 [min] | 1.6 | 1.4 | 1.4 | 1.5 | 1.2 | 1.2 | 1.2 | 1.2 | 1.2 | 1.2 |
| ts2 [min] | 2.8 | 2.0 | 1.8 | 1.9 | 1.8 | 1.6 | 1.5 | 1.7 | 1.5 | 1.5 |
| t10 [min] | 1.4 | 1.2 | 1.0 | 0.8 | 1.1 | 1.1 | 1.0 | 1.1 | 1.0 | 1.0 |
| t20 [min] | 2.5 | 1.7 | 1.5 | 1.5 | 1.6 | 1.4 | 1.2 | 1.5 | 1.3 | 1.2 |
| t30 [min] | 3.6 | 2.2 | 1.7 | 1.7 | 2.1 | 1.6 | 1.4 | 1.9 | 1.5 | 1.4 |
| t40 [min] | 5.0 | 2.7 | 2.0 | 1.8 | 2.5 | 1.9 | 1.6 | 2.2 | 1.7 | 1.6 |
| t50 [min] | 6.6 | 3.2 | 2.4 | 2.0 | 3.0 | 2.2 | 1.8 | 2.6 | 2.0 | 1.8 |
| t60 [min] | 8.8 | 3.8 | 2.9 | 2.3 | 3.6 | 2.5 | 2.2 | 3.1 | 2.2 | 2.1 |
| t70 [min] | 11.9 | 4.7 | 3.6 | 2.9 | 4.3 | 3.1 | 3.0 | 3.7 | 2.6 | 2.7 |
| t80 [min] | 16.9 | 6.0 | 5.4 | 5.6 | 5.4 | 4.3 | 5.4 | 4.6 | 3.3 | 5.3 |
| t90 [min] | 26.4 | 9.0 | 14.1 | 22.9 | 7.9 | 11.4 | 16.9 | 6.4 | 6.4 | 16.3 |

Table 5 provides the hardness, tensile, and tear properties of the ten samples. This data illustrates that after curing the hardness of the elastomeric composition samples is less than the control and the tear force is increased, which translates to a more stable tire curing bladder that will likely have a longer lifetime than a butyl rubber tire curing bladder.

TABLE 5
Hardness, tensile, and tear properties

| | | | | | | | | | | |
|---|---|---|---|---|---|---|---|---|---|---|
| Sample No. | 1 | 2 | 3 | 4 | 5 | 6 | 7 | 8 | 9 | 10 |

Hardness Shore A (Wallace); ASTM D2240-15e1
Cure Condition: tc90 + 2 @ 190° C. MDR

| | | | | | | | | | | |
|---|---|---|---|---|---|---|---|---|---|---|
| Hardness Original | 60 | 60 | 58 | 57 | 60 | 58 | 58 | 59 | 58 | 59 |
| [Shore A] | | | | | | | | | | |
| Hardness air aged 2 | 86 | 74 | 74 | 73 | 74 | 74 | 72 | 74 | 74 | 75 |
| days @ 177° C. | | | | | | | | | | |
| [Shore A] | | | | | | | | | | |
| Hardness Steam | 69 | 58 | 55 | 52 | 61 | 58 | 55 | 61 | 59 | 58 |
| aged 3 days @ | | | | | | | | | | |
| 170° C. [Shore A] | | | | | | | | | | |

Tensile Test (original); ASTM D412-16
Cure Condition: tc90 + 2 @ 190° C. MDR

| | | | | | | | | | | |
|---|---|---|---|---|---|---|---|---|---|---|
| Modulus at 100% | 1.7 | 2.0 | 1.6 | 1.4 | 2.3 | 1.8 | 1.5 | 2.1 | 1.8 | 1.5 |
| [MPa] | | | | | | | | | | |
| Modulus at 200% | 3.3 | 5.1 | 3.5 | 2.7 | 6.3 | 4.4 | 3.2 | 5.8 | 4.7 | 3.4 |
| [MPa] | | | | | | | | | | |
| Modulus at 300% | 5.5 | 9.4 | 6.4 | 4.6 | 10.9 | 8.0 | 5.8 | 10.5 | 8.2 | 6.2 |
| [MPa] | | | | | | | | | | |
| Tensile Strength at | 14.5 | 15.9 | 14.7 | 11.8 | 16.4 | 16.1 | 15.7 | 15.5 | 16.1 | 15.3 |
| break [MPa] | | | | | | | | | | |
| Elongation at break | 690 | 480 | 600 | 760 | 450 | 580 | 740 | 430 | 600 | 700 |
| [%] | | | | | | | | | | |
| Energy at Break [J] | 14.5 | 10.5 | 12.8 | 15.4 | 10.9 | 13.2 | 17.2 | 9.2 | 14.8 | 15.9 |

Tensile Test (air aged 2 days @ 177° C.); ASTM D412-16
Cure Condition: tc90 + 2 @ 190° C. MDR

| | | | | | | | | | | |
|---|---|---|---|---|---|---|---|---|---|---|
| Modulus at 100% | 4.2 | 2.9 | 3.3 | 2.9 | 3.6 | 3.3 | 3.0 | 3.3 | 3.5 | 3.2 |
| [MPa] | | | | | | | | | | |
| Modulus at 200% | 6.9 | 6.6 | 6.9 | 5.4 | 8.2 | 7.1 | 6.2 | 7.3 | 7.1 | 6.3 |
| [MPa] | | | | | | | | | | |
| Modulus at 300% | 9.3 | 11.3 | 10.9 | 8.3 | 12.9 | 11.2 | 10.1 | 11.7 | 10.8 | 9.4 |
| [MPa] | | | | | | | | | | |
| Tensile Strength at | 9.4 | 15.9 | 14.9 | 13.1 | 15.7 | 15.4 | 14.6 | 14.5 | 13.6 | 12.9 |
| break [MPa] | | | | | | | | | | |
| Elongation at break | 300 | 410 | 430 | 520 | 380 | 430 | 480 | 390 | 400 | 460 |
| [%] | | | | | | | | | | |
| Energy at Break [J] | 5.3 | 8.9 | 9.7 | 11.2 | 8.9 | 9.9 | 10.8 | 8.5 | 8.9 | 9.8 |

Tensile Test (steam aged 3 days @ 170° C.); ASTM D412-16
Cure Condition: tc90 + 2 @ 190° C. MDR

| | | | | | | | | | | |
|---|---|---|---|---|---|---|---|---|---|---|
| Modulus at 100% | 2.8 | 2.5 | 2.1 | 1.7 | 2.5 | 2.2 | 1.8 | 2.4 | 2.1 | 1.9 |
| [MPa] | | | | | | | | | | |
| Modulus at 200% | 5.6 | 6.3 | 5.4 | 3.8 | 6.7 | 5.6 | 4.4 | 6.4 | 5.4 | 4.7 |
| [MPa] | | | | | | | | | | |
| Modulus at 300% | 9.0 | 10.9 | 9.7 | 6.5 | 11.8 | 10.0 | 8.2 | 11.5 | 9.6 | 8.6 |
| [MPa] | | | | | | | | | | |
| Tensile Strength at | 14.2 | 13.9 | 13.4 | 9.0 | 16.2 | 15.4 | 13.5 | 16.5 | 15.4 | 14.3 |
| break [MPa] | | | | | | | | | | |
| Elongation at break | 490 | 370 | 400 | 400 | 410 | 440 | 460 | 430 | 480 | 490 |
| [%] | | | | | | | | | | |
| Energy at Break [J] | 10.5 | 7.2 | 7.2 | 4.9 | 8.8 | 9.1 | 8.1 | 9.5 | 10.7 | 10.2 |

DIE C Tear Test; ASTM D624-00(2012)
Cure Condition: tc90 + 2 @ 190° C. MDR

| | | | | | | | | | | |
|---|---|---|---|---|---|---|---|---|---|---|
| Original [N/mm] | 45.6 | 33.8 | 37.8 | 40.1 | 31.7 | 38.8 | 40.7 | 34.4 | 38.8 | 42.7 |
| Hot air aged 2 days | 30.9 | 41.1 | 42.2 | 45.2 | 40.3 | 42.4 | 44.8 | 39.7 | 42.5 | 42.8 |
| @ 177° C. [N/mm] | | | | | | | | | | |
| Steam aged 3 days | 38.3 | 30.3 | 26.6 | 25.2 | 33.4 | 31.2 | 30.7 | 35.8 | 37.5 | 34.7 |
| @ 170° C. [N/mm] | | | | | | | | | | |

Table 6 provides the tension set, DeMattia crack initiation, permeability, and fatigue to failure lifetime test (FTFT) properties of the ten samples. This data illustrates that the tension set can be adjusted by adjusting the curing system composition. Further, the fatigue to failure lifetime test gives a relative indication of the lifetime of tire cure bladders produced from the various samples. Many of the elastomeric compositions described herein greatly outperform the butyl rubber (Sample 1).

TABLE 6
Tension set, DeMattia crack initiation, permeability, and FTFT

| | | | | | | | | | | |
|---|---|---|---|---|---|---|---|---|---|---|
| Sample No. | 1 | 2 | 3 | 4 | 5 | 6 | 7 | 8 | 9 | 10 |

Tension set test-Method B-300% Elongation (Bladder Compound);
Cure Condition: tc90 + 2 @ 190° C. MDR

| | | | | | | | | | | |
|---|---|---|---|---|---|---|---|---|---|---|
| Temp. [° C.] | 100 | 100 | 100 | 100 | 100 | 100 | 100 | 100 | 100 | 100 |
| Time [hrs] | 1 | 1 | 1 | 1 | 1 | 1 | 1 | 1 | 1 | 1 |
| Relaxation | 24 | 24 | 24 | 24 | 24 | 24 | 24 | 24 | 24 | 24 |
| time [hrs] | | | | | | | | | | |
| Tension Set | 14.1 | 12.3 | 12.2 | 22.8 | 12.4 | 10.1 | 14.8 | 14.0 | 14.0 | 16.3 |
| [%] | | | | | | | | | | |

DeMattia Crack Initiation (NC = No Crack); ASTM D430-06(2012)
Cure Condition: tc90 + 5 @ 190° C. MDR

| | | | | | | | | | | |
|---|---|---|---|---|---|---|---|---|---|---|
| KC200(avg) | NC | NC | NC | NC | NC | NC | NC | NC | NC | NC |
| [mm] | | | | | | | | | | |

Mocon Oxygen Transmission Test;
Cure Condition: tc90 + 2 @ 190° C. MDR

| | | | | | | | | | | |
|---|---|---|---|---|---|---|---|---|---|---|
| Temperature | 40 | 40 | 40 | 40 | 40 | 40 | 40 | 40 | 40 | 40 |
| (Set) [° C.] | | | | | | | | | | |
| Permeation | 155.6 | 131.5 | 123.8 | 120.8 | 125.6 | 114.1 | 119.4 | 113.9 | 117.5 | 116.0 |
| [(mm) · (cc)/ | | | | | | | | | | |
| m² · day | | | | | | | | | | |
| Permeability | 0.23 | 0.19 | 0.18 | 0.18 | 0.18 | 0.17 | 0.17 | 0.17 | 0.17 | 0.17 |
| Coefficient | | | | | | | | | | |
| [(mm) · (cc)/ | | | | | | | | | | |
| m² · day · | | | | | | | | | | |
| mmHg] | | | | | | | | | | |
| Permeance | 0.39 | 0.35 | 0.32 | 0.30 | 0.29 | 0.29 | 0.30 | 0.26 | 0.33 | 0.29 |
| Coefficient | | | | | | | | | | |
| [(cc)/m² · day · | | | | | | | | | | |
| mmHg] | | | | | | | | | | |

FTFT; Temperature: 23 ± 2° C., % Extension: 136 (CAM 24)
Cure Condition: 60 Minute at 190° C.

| | | | | | | | | | | |
|---|---|---|---|---|---|---|---|---|---|---|
| Average | 69.5 | 49.6 | 200.8 | 300.0 | 92.8 | 92.0 | 259.8 | 63.1 | 70.1 | 198.8 |
| [k-cycles]* | | | | | | | | | | |
| Std. Dev. | 32.5 | 33.1 | 106.5 | 0.0 | 68.4 | 72.0 | 52.8 | 61.2 | 48.6 | 66.9 |
| Maximum | 119.1 | 114.6 | 300.0 | 300.0 | 182.8 | 204.8 | 300.0 | 186.8 | 178.2 | 300.0 |
| [k-cycles] | | | | | | | | | | |
| Minimum | 20.9 | 13.6 | 77.8 | 300.0 | 14.6 | 8.9 | 179.2 | 11.2 | 14.7 | 111.7 |
| [k-cycles] | | | | | | | | | | |

*k-cycles is 1000 cycles, so 69.5 is 69,500 cycles. 300.0 k-cycles means the specimens did not break after 24 hrs from the complete removal of the loop.

Table 7 provides the hardness, tensile, and tension set properties with varied curing times of the ten samples. This data illustrates that the elastomeric compositions described herein cure completely (to a Hardness of about 60 Shore A) much faster than the butyl rubber (Sample 1). Further, at those cure times, the other mechanical properties are comparable or better than the butyl rubber.

TABLE 7
Hardness, tensile, and tension set with varied curing times

| | | | | | | | | | | |
|---|---|---|---|---|---|---|---|---|---|---|
| Sample No. | 1 | 2 | 3 | 4 | 5 | 6 | 7 | 8 | 9 | 10 |

Hardness Shore A (Wallace); ASTM D2240-15e1
Cure Condition: tc90 + 2 @ 190° C. MDR

| | | | | | | | | | | |
|---|---|---|---|---|---|---|---|---|---|---|
| Cure Time at | 28 | 11 | 16 | 25 | 10 | 13 | 19 | 8 | 8 | 18 |
| 190° C. [min] | | | | | | | | | | |
| Hardness | 60 | 60 | 58 | 57 | 60 | 58 | 58 | 59 | 58 | 59 |
| Original [Shore | | | | | | | | | | |
| A] | | | | | | | | | | |

Hardness Shore A (Wallace); ASTM D2240-15e1
Cure Condition: 60 minute at @ 190° C. MDR

| | | | | | | | | | | |
|---|---|---|---|---|---|---|---|---|---|---|
| Cure Time at | 60 | 60 | 60 | 60 | 60 | 60 | 60 | 60 | 60 | 60 |
| 190° C. [min] | | | | | | | | | | |
| Hardness | 61 | 60 | 59 | 58 | 61 | 59 | 58 | 61 | 59 | 59 |
| Original [Shore | | | | | | | | | | |
| A] | | | | | | | | | | |

Tensile Test (original); ASTM D412-16
Cure Condition: tc90 + 2 @ 190° C. MDR

| | | | | | | | | | | |
|---|---|---|---|---|---|---|---|---|---|---|
| Cure Time at | 28 | 11 | 16 | 25 | 10 | 13 | 19 | 8 | 8 | 18 |
| 190° C. [min] | | | | | | | | | | |
| Modulus at 100% | 1.7 | 2.0 | 1.6 | 1.4 | 2.3 | 1.8 | 1.5 | 2.1 | 1.8 | 1.5 |
| [MPa] | | | | | | | | | | |
| Modulus at 200% | 3.3 | 5.1 | 3.5 | 2.7 | 6.3 | 4.4 | 3.2 | 5.8 | 4.7 | 3.4 |
| [MPa] | | | | | | | | | | |
| Modulus at 300% | 5.5 | 9.4 | 6.4 | 4.6 | 10.9 | 8.0 | 5.8 | 10.5 | 8.2 | 6.2 |
| [MPa] | | | | | | | | | | |
| Tensile Strength | 14.5 | 15.9 | 14.7 | 11.8 | 16.4 | 16.1 | 15.7 | 15.5 | 16.1 | 15.3 |
| at break [MPa] | | | | | | | | | | |
| Elongation at | 690 | 480 | 600 | 760 | 450 | 580 | 740 | 430 | 600 | 700 |
| break [%] | | | | | | | | | | |
| Energy at Break | 14.5 | 10.5 | 12.8 | 15.4 | 10.9 | 13.2 | 17.2 | 9.2 | 14.8 | 15.9 |
| [J] | | | | | | | | | | |

Tensile Test (original); ASTM D412-16
Cure Condition: 60 minute at @ 190° C. MDR

| | | | | | | | | | | |
|---|---|---|---|---|---|---|---|---|---|---|
| Cure Time at | 60 | 60 | 60 | 60 | 60 | 60 | 60 | 60 | 60 | 60 |
| 190° C. [min] | | | | | | | | | | |
| Modulus at 100% | 2.0 | 2.2 | 1.8 | 1.5 | 2.3 | 1.9 | 1.5 | 2.2 | 2.0 | 1.7 |
| [MPa] | | | | | | | | | | |
| Modulus at 200% | 3.8 | 5.5 | 4.1 | 3.0 | 6.0 | 4.6 | 3.0 | 5.8 | 4.9 | 3.8 |
| [MPa] | | | | | | | | | | |
| Modulus at 300% | 6.2 | 10.0 | 7.4 | 5.1 | 10.8 | 8.4 | 5.5 | 10.6 | 8.8 | 6.9 |
| [MPa] | | | | | | | | | | |
| Tensile Strength | 14.5 | 16.2 | 15.3 | 12.6 | 16.5 | 16.8 | 15.4 | 17.3 | 15.6 | 15.5 |
| at break [MPa] | | | | | | | | | | |
| Elongation at | 680 | 450 | 580 | 670 | 450 | 550 | 690 | 490 | 520 | 660 |
| break [%] | | | | | | | | | | |
| Energy at Break | 15.0 | 9.5 | 12.6 | 13.4 | 10.7 | 13.0 | 14.6 | 12.8 | 11.2 | 15.0 |
| [J] | | | | | | | | | | |
| Hot Air Aging | 28 | 85 | 73 | 76 | 81 | 71 | 60 | 85 | 56 | 55 |
| Resistance# [%] | | | | | | | | | | |

Tension set test-Method B-300% Elongation (Bladder Compound);
Cure Condition: tc90 + 2 @ 190° C. MDR

| | | | | | | | | | | |
|---|---|---|---|---|---|---|---|---|---|---|
| Cure Time at | 28 | 11 | 16 | 25 | 10 | 13 | 19 | 8 | 8 | 18 |
| 190° C. [min] | | | | | | | | | | |
| Temperature [° C.] | 100 | 100 | 100 | 100 | 100 | 100 | 100 | 100 | 100 | 100 |
| Time [Hrs] | 1 | 1 | 1 | 1 | 1 | 1 | 1 | 1 | 1 | 1 |
| Relaxation time | 24 | 24 | 24 | 24 | 24 | 24 | 24 | 24 | 24 | 24 |
| [hrs] | | | | | | | | | | |
| Tension Set [%] | 14.1 | 12.3 | 12.2 | 22.8 | 12.4 | 10.1 | 14.8 | 14.0 | 14.0 | 16.3 |

Tension set test-Method B-300% Elongation (Bladder Compound);
Cure Condition: 60 minute at @ 190° C. MDR

| | | | | | | | | | | |
|---|---|---|---|---|---|---|---|---|---|---|
| Cure Time at | 60 | 60 | 60 | 60 | 60 | 60 | 60 | 60 | 60 | 60 |
| 190° C. [min] | | | | | | | | | | |
| Temperature [° C.] | 100 | 100 | 100 | 100 | 100 | 100 | 100 | 100 | 100 | 100 |
| Time [hrs] | 1 | 1 | 1 | 1 | 1 | 1 | 1 | 1 | 1 | 1 |
| Relaxation time | 24 | 24 | 24 | 24 | 24 | 24 | 24 | 24 | 24 | 24 |
| [hrs] | | | | | | | | | | |
| Tension Set [%] | 12.5 | 11.1* | 13.2 | 22.5 | 8.4 | 9.2 | 15.0 | 9.2 | 13.2 | 14.7 |

*one out of two specimens broke

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A composition comprising:
an elastomeric composition formed into a curing bladder, the elastomeric composition comprising:
100 parts per hundred parts rubber (phr) of an elastomer comprising a C₄-C₇ isoolefin, a non-halogenated alkylstyrene, and a halogenated alkylstyrene;
1 phr to 7.5 phr alkyl phenol formaldehyde resin; and
0.5 phr to 5 phr mercaptobenzothiazole disulfide.

2. The composition of claim 1, wherein the alkyl phenol formaldehyde resin comprises octyl phenol formaldehyde resin and/or brominated octyl phenol formaldehyde resin.

3. The composition of claim 1, wherein the alkyl phenol formaldehyde resin is present at about 3 phr to about 5 phr.

4. The composition of claim 1, wherein the mercaptobenzothiazole disulfide is present at 1.4 phr to about 2.0 phr.

5. The composition of claim 1, wherein the C₄-C₇ isoolefin comprises isobutylene.

6. The composition of claim 1, wherein the non-halogenated alkylstyrene comprises paramethylstyrene.

7. The composition of claim 1, wherein the halogenated alkylstyrene comprises brominated paramethylstyrene.

8. The composition of claim 1, wherein the non-halogenated alkylstyrene and the halogenated alkylstyrene cumulatively are present in the elastomer composition in the amount of greater than or equal to about 10 wt % based on the elastomer composition.

9. The composition of claim 1, wherein the halogenated alkylstyrene is present at from 0.1 mol % to 7.5 mol % relative to the non-halogenated alkylstyrene.

10. The composition of claim 1, wherein the C₄-C₇ isoolefin is present in the elastomer composition in the amount of less than or equal to about 90 wt % based on the elastomer composition.

11. The composition of claim 1 further comprising a processing aid and a filler.

12. The composition of claim 11, wherein the filler comprises carbon black.

13. The composition of claim 11, wherein the filler comprises clay.

14. The composition of claim 1, wherein the elastomeric composition further comprises 0.5 phr to 30 phr butyl rubber.

15. A method of making a tire curing bladder comprising:
mixing 100 parts per hundred parts rubber (phr) of an elastomer composition comprising a C₄-C₇ isoolefin, a non-halogenated alkylstyrene, and a halogenated alkylstyrene, 1 phr to 7.5 phr alkyl phenol formaldehyde resin, and 0.5 phr to 5 phr mercaptobenzothiazole disulfide; and
molding and curing the mixture into the shape of a tire curing bladder.

16. The method of claim 15, wherein curing is for less than 30 minutes at about 170° C. to about 200° C.

17. The method of claim 15, wherein curing is for about 45 minutes to about 90 minutes at about 120° C. to about 150° C.

18. The method of claim 15, wherein the alkyl phenol formaldehyde resin comprises octyl phenol formaldehyde resin and/or brominated octyl phenol formaldehyde resin.

19. The method of claim 15, wherein the alkyl phenol formaldehyde resin is present at about 3 phr to about 5 phr.

20. The method of claim 15, wherein the mercaptobenzothiazole disulfide is present at 1.4 phr to about 2.0 phr.

21. The method of claim 15, wherein the C₄-C₇ isoolefin comprises isobutylene.

22. The method of claim 15, wherein the non-halogenated alkylstyrene comprises paramethylstyrene.

23. The method of claim 15, wherein the halogenated alkylstyrene comprises brominated paramethylstyrene.

24. The method of claim 15 further comprising a processing aid and a filler.

25. The method of claim 15, wherein the elastomer composition further comprises 0.5 phr to 30 phr butyl rubber.
